(19) United States
(12) Patent Application Publication
(10) Pub. No.: US 2004/0019661 A1
(43) Pub. Date: Jan. 29, 2004

(54) Method and apparatus for retrying and redirecting network requests

(76) Inventors: Andreas E. Eleftheriou, Ramona, CA (US); Brian E. McGeary, El Cajon, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/206,241

(22) Filed: Jul. 26, 2002

(51) Int. Cl. G06F 15/16

(52) U.S. Cl. 709/219

(57) ABSTRACT

A method and apparatus for processing network requests is generally described.

### FIELD

Embodiments of the invention are generally related to the field of data networking and, in particular, to a method and apparatus for retrying and redirecting network requests.

### BACKGROUND

Data networking is a term typically applied to any architecture wherein electronic devices (e.g., computer systems, communication devices, electronic appliances, etc.) are communicatively coupled to one another through a network architecture. The network architecture is typically comprised of a number of network devices, e.g., routers, switches, and hubs, which serve to route data packets between nodes comprising the packet-switched communication path from a source electronic device to a target electronic device.

When a user operating the source electronic device (a client) accesses a network location (a service), e.g., a World Wide Web site, and makes a request, a network traffic manager (NTM) can be used to receive the request. The NTM forwards the request to the target electronic device (a server), which provides a response to the request. An example of a NTM is a load balancer, which distributes requests among multiple servers (e.g., cumulatively, the target electronic device) connected with the load balancer, in order to reduce the workload on any one server. A NTM may be a dedicated computer system that performs network traffic management functions, or a part of a network device that performs load balancing functions in addition to other functions, e.g., a switch that has load balancing capabilities in addition to switching capabilities.

If a server provides a response to a request forwarded from a NTM, the NTM receives the response and transmits the response to the client. However, if the NTM receives a request but is unable to forward the request to a server, e.g., because the NTM's resources are unavailable (e.g., the NTM is out of memory or has exceeded its maximum bandwidth), the NTM transmits to the client a message (e.g., “service unavailable”) indicating that a response to the request has not been provided. The NTM transmits a similar message to the client (e.g., “service unavailable”) if the NTM is able to forward the request but does not receive a response because a server or servers are unavailable.

In some cases, the NTM is only temporarily unable to forward a request, or a server or servers are only temporarily unavailable to provide a response to a request that is forwarded. However, a user of the client typically is unaware that the failure to receive a response is due to the temporary inability of the NTM to forward the request or the temporary unavailability of a server. Similarly, the user is typically unaware that despite a message such as “service unavailable,” a response may be provided if the request is retried. Consequently, the user may decide to access a different service in order to fulfill the request, which results in lost business for the current service.

### DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram illustrating an example data network within which embodiments of the invention may be practiced.

FIG. 2 is one embodiment of a flow chart illustrating an example method of operation of an enhanced network traffic manager, according to one embodiment of the invention.

FIG. 3 is a block diagram of one embodiment of an electronic system depicting alternate embodiments of the invention.

### DESCRIPTION

A method and apparatus for retrying and redirecting network requests is generally described. In this regard, an enhanced network traffic manager (NTM) is introduced including a retry module and a redirect module. As will be presented more thoroughly below, the addition of one or both of the retry module and the redirect module enable the enhanced NTM to provide automatic retry and redirect services, improving the perceived availability of network servers supported by the enhanced NTM.

In the following description, for purposes of explanation, numerous specific details are set forth. It will be apparent, however, to one skilled in the art that embodiments of the invention can be practiced without these specific details. In other instances, structures and devices are shown in block diagram form in order to avoid obscuring the understanding of this description.

FIG. 1 is a block diagram illustrating an example data network 100 within which embodiments of the present invention may be practiced. As shown, network 100 is presented comprising a source (or, client) computing appliance 102, network architecture 104, network device 106 and one or more target computing appliance(s) (e.g., servers) 108A . . . N, each coupled as depicted. In accordance with one example embodiment, network device 106 is depicted comprising an enhanced network traffic manager (NTM) 110 incorporating innovative retry and redirect facilities.

As used herein, client computing appliance 102 is intended to represent any of a wide variety of electronic devices from which a user transmits a request intended for target computing appliance 108A . . . N. In this regard, the requesting computing appliance 102 is intended to represent a wide variety of electronic devices/network elements known in the art such as, for example, a desktop computing platform, a notebook computing platform, a handheld device (e.g., a personal digital assistant), a mobile communications device, etc. There is no restriction or requirement regarding the number of requesters 110 that may be coupled with network 120.

Network architecture 104 is intended to represent any of a wide variety of network architectures known in the art. In this regard, network architecture 104 may well represent a local area network (LAN), a wide area network (WAN), a metropolitan area network (MAN), a global internetwork (Internet), and the like. As used herein, computing appliances 102 and 108A . . . N as well as network device(s) 106 include communication resources to facilitate the communication described herein via network architecture 104.

Network device 106is intended to represent any of a number of electronic devices which facilitate communication between end-points appliances (e.g., computing appliances, communication appliances, electronic devices, etc.). In this regard, but for the inclusion of the innovative network traffic manager 110 described more fully below, network device 106 is intended to represent any of a wide variety of network devices (e.g., hub, switch, router, server, wireless basestation, etc.) for routing data packets between nodes in a network. Thus, network device 106 may be a device dedicated to routing, or may be any number of devices that include the ability to route data packets between nodes in a network, though not solely dedicated to routing data packets.

As shown, network device 106 includes an example embodiment of network traffic manager 110. According to one implementation, NTM 110 is implemented as a software/firmware application executed by control logic resident within network device 106. In alternate implementations, NTM 110 is embodied as an application specific integrated circuit (ASIC), special purposes processor, a microcontroller, a field-programmable gate array (FPGA), or some other control circuitry residing in network device 106 to perform management functions, including those taught herein. It will be appreciated by those skilled in the art, based on the disclosure herein, that there is no restriction or requirement regarding the number of target devices 108A . . . N that may be coupled with network device 106 to share the support services of retry module or the redirect module.

As will be described in more detail below, network device 106 receives requests targeting one or more target computing appliances 108A . . . N. Network traffic manager 110 identifies whether resources are available (either at network device 106 or at the target appliances 108A . . . N) and, if so, forwards the request to an appropriate one or more of appliance(s) 108A . . . N. If a response from computing appliance 108 is received within a managed timeframe, network traffic manager 110 passes the response via network device 106 and network architecture 104 to the requesting client computing appliance (e.g., 102). If, however, network traffic manager 110 identifies that there are insufficient resources to support the received request, or the target computing appliance 108 fails to respond to a forwarded request within the managed timeframe, network traffic manager 110 invokes one or more of an innovative retry module and/or a redirect module.

As used herein, the retry module of the NTM 110 performs an automatic retry of client requests to a target 108A . . . N that has returned an indication of unavailability to a forwarded request. According to one example implementation, the retry message directs the browser (or, any application that sourced the request) executing on the client computing appliance 102 to automatically reissue (retry) the request. In certain implementations, a user of the client computing appliance 102 may or may not be informed that the automatic retry is occurring. According to one embodiment, network traffic manager 110 invokes an instance of retry module whenever any of the following thresholds are reached: (1) maximum allowed connections to target server(s) 108A . . . N; (2) maximum supported concurrent connections in network device 110; (3) maximum allowed memory usage in network device 110; (4) maximum allowed memory usage in network device 110; or (5) maximum allowed bandwidth usage in network device 110.

The redirect module of NTM 110 is selectively invoked to direct a received request to an alternate network resource (e.g., another server, service, etc.) in the event that the target 108A . . . N cannot process the client request (e.g., no servers 108A . . . N are available to handle the request). According to one example embodiment, if network traffic manager 110 determines that a request cannot be serviced by the target computing appliance(s) 108A . . . N, NTM 110 invokes an instance of the redirect module to identify and redirect a browser (or other application acting as the source of the request) executing on the client computing appliance 102 to direct the request to an specified alternate target. In this regard, the retry and redirect module improve the ability of the network device 106 to fulfill requests received from client computing appliances 102, giving a user of such a device the perception of improved availability of the target resources 108A . . . N supported by the network device 106 endowed with NTM 110.

As used herein, target computing appliance(s) 108A . . . N are intended to represent any of a wide variety of network based servers and/or services that are accessible to client computing appliances 102. As used herein, target computing appliance 108A . . . N is intended to represent a wide variety of electronic devices/network elements known in the art such as, for example, a server, a desktop computing appliance, a notebook computing platform, a handheld device (e.g., a personal digital assistant), a mobile communications device, and the like. As such devices are well known in the art, they need not be further described herein.

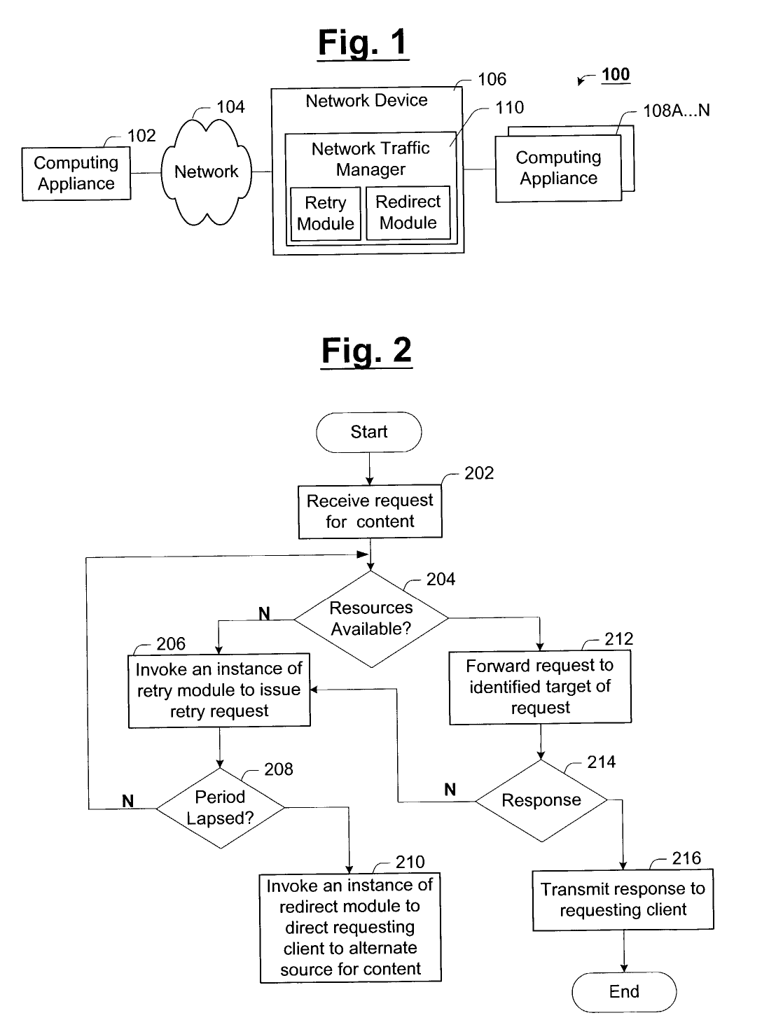

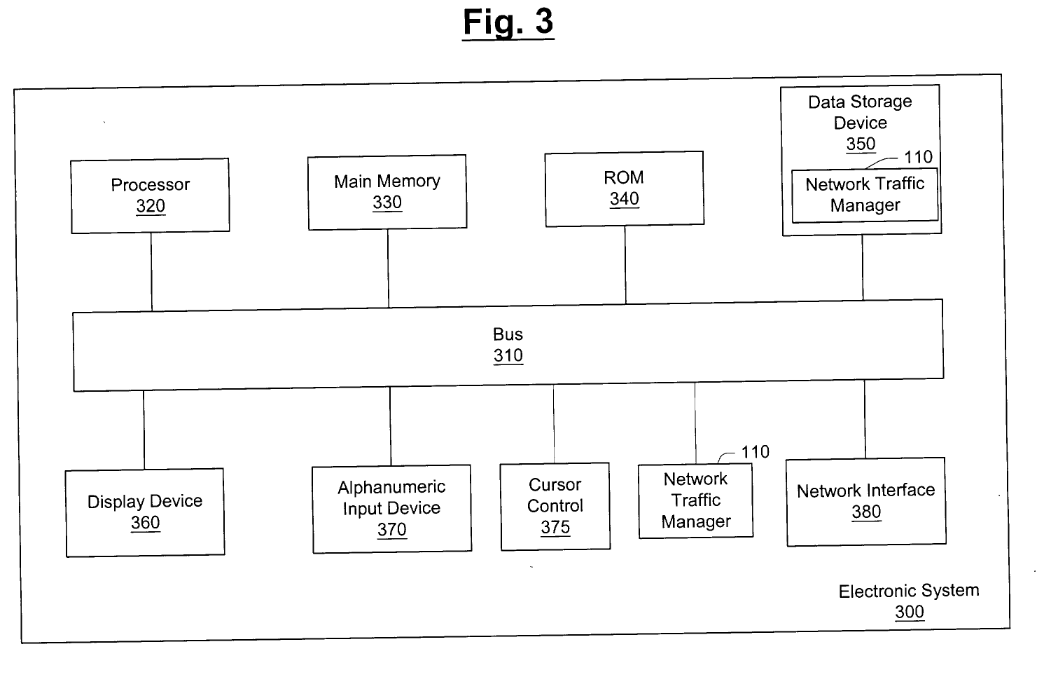

FIG. 2 is a flow chart illustrating an example method of processing network requests in accordance with one example embodiment of the invention. For ease of illustration, and not limitation, the method of FIG. 2 will be developed with continued reference to the network elements of FIG. 1, as appropriate. Nonetheless, it is to be appreciated that the illustrative teachings of FIG. 2 may well be implemented in alternate network architectures/configurations without deviating from the spirit and scope of the present invention.

In accordance with the illustrated example embodiment, the method of FIG. 2 begins with block 202 wherein network device 106 receives a request for content (or, network services) from one or more supported target computing appliance(s) 108A . . . N. More specifically, network traffic manager 110 of network device 106 receives the request from client computing appliance 102 for selective routing to an appropriate one or more of the computing appliance(s) 108A . . . N supported by network device 106.

In block 204, network traffic manager 110 determines whether there are resources available to service the request. According to one embodiment, as introduced above, network traffic manager 110 determines whether there are sufficient resources (e.g., memory, bandwidth, processor resources, etc.) within network device 106 to service the request. In one embodiment, network traffic manager 110 determines whether the target computing appliance(s) 108A . . . N have sufficient resources to service the request.

If, in block 204, network traffic manager 110 determines that one or more of network device 106 or target computing appliance(s) 108A . . . N do not have adequate resources to service the request, network traffic manager 110 invokes an instance of retry module to process the request. As introduced above, the retry module of network traffic manager 110 sends a retry message to the requesting client computing appliance 102, which causes a source application (e.g., a browser) executing on the client computing appliance 102 to reissue a request for content. According to one embodiment, the retry message sent by retry module of the NTM 110 includes a message for a user of the client computing appliance 102 to standby as the request for content is processed.

According to one embodiment, the retry module of network traffic manager 110 will continue to issue retry messages until a retry period has lapsed, block 208. According to one embodiment, the retry period is pre-determined in the manufacture of network traffic manager 110. In one embodiment, the retry period is dynamically determined by a network administrator. Once the retry period of block 208 has lapsed, network traffic manager 110 invokes an instance of redirect module, block 210.

As introduced above, redirect module of network traffic manager 110 identifies an alternate target computing appliance with which to reply to the request from the client computing appliance 102. Once the alternate target computing appliance is identified, redirect module of network traffic manager 110 generates a redirect message, which causes a receiving source application (e.g., browser) executing on the client computing appliance 102 to automatically issue a request to the alternate target computing appliance identified in the redirect message, block 210.

If in block 204, network traffic manager 110 determines that network device 106 (or, target computing appliance(s) 108A . . . N) have adequate resources to support the request, network traffic manager 110 selectively forwards the received request to an identified one or more target computing appliance(s) 108A . . . N, block 212. Once the request is forwarded, network traffic manager 110 monitors whether a response to the request is received from the target computing appliance(s) 108A . . . N, block 214.

If, in block 214, a response is not received within some response period, network traffic manager 110 invokes an instance of retry module and the process continues with block 206, discussed above. In block 216, if the response is received within the response period, network traffic manager 110 transmits the response to the requesting client computing appliance 102.

FIG. 3 is a block diagram of one embodiment of an electronic system architecture within which the teachings of the invention may be practiced, according to one embodiment of the invention. As shown, electronic system 300 is intended to represent a range of electronic systems, including, for example, a personal computer, a personal digital assistant (PDA), a laptop or palmtop computer, a cellular phone, a computer system, a network access device, etc. Other electronic systems can include more, fewer and/or different components while still supporting the teachings of the present invention. In one embodiment, the technique of FIG. 1 can be implemented as sequences of instructions executed by an electronic system. The sequences of instructions can be stored by the electronic system, or the instructions can be received by the electronic system (e.g., via a network connection). The electronic system can be coupled to a wired or wireless network.

In accordance with the illustrated example embodiment of FIG. 3, electronic system 300 is depicted comprising a bus 310 or other communication channel(s) to communicate information, and processor 320 coupled to bus 310 to process information. While electronic system 300 is illustrated with a single processor, electronic system 300 may well include multiple processors and/or co-processors.

Electronic system 300 further includes random access memory (RAM) or other dynamic storage device(s) 330 (referred to as memory), coupled to bus 310 to store information and instructions to be executed by processor 320. Memory 330 also can be used to store temporary variables or other intermediate information while processor 320 is executing instructions. According to one example implementation, network traffic manager 110, with constituent retry module and redirect module, is implemented as software within data storage device 350. In an alternate embodiment, also depicted, network traffic manager 110 is implemented in hardware (e.g., the previously mentioned ASIC, microcontroller, FPGA, etc.) coupled to bus 310.

Electronic system 300 may also include read-only memory (ROM) and/or other static storage device 340 coupled to bus 310 to store static information and instructions for processor 320. In addition, data storage device 350 is coupled to bus 310 to store information and instructions. Data storage device 350 may comprise a magnetic disk (e.g., a hard disk) or optical disc (e.g., a CD-ROM) and corresponding drive.

Electronic system 300 may further comprise a display device 360, such as a cathode ray tube (CRT) or liquid crystal display (LCD), to display information to a user. Alphanumeric input device 370, including alphanumeric and other keys, is typically coupled to bus 310 to communicate information and command selections to processor 320. Another type of user input device is cursor control 375, such as a mouse, a trackball, or cursor direction keys to communicate direction information and command selections to processor 320 and to control cursor movement on flat-panel display device 360. Electronic system 300 further includes network interface 380 to provide access to a network, such as a local area network.

Instructions are provided to memory from a machine-accessible medium, or an external storage device accessible via a remote connection (e.g., over a network via network interface 380) providing access to one or more electronically-accessible media, etc. A machine-accessible medium includes any mechanism that provides (i.e., stores and/or transmits) information in a form readable by a machine (e.g., a computer). For example, a machine-accessible medium includes RAM; ROM; magnetic or optical storage medium; flash memory devices; electrical, optical, acoustical or other form of propagated signals (e.g., carrier waves, infrared signals, digital signals); etc.

In alternative embodiments, hard-wired circuitry can be used in place of or in combination with software instructions to implement the embodiments of the present invention. Thus, the embodiments of the present invention are not limited to any specific combination of hardware circuitry and software instructions.

Reference in the foregoing specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the foregoing specification, the invention has been described with reference to specific embodiments thereof. It will, however, be evident that various modifications and changes can be made thereto without departing from the broader spirit and scope of the invention. The specfication and drawings are, accordingly, to be regarded in an illustrative rather than a restrictive sense.

What is claimed is:

1. A method comprising:
receiving a request from a computing appliance directed to a target computing appliance;
selectively forwarding the received request to the target computing appliance; and
transmitting a retry message to the requesting computing appliance, if a response to the forwarded request is not received from the target computing appliance, the retry message causing the requesting computing appliance to automatically issue another request.

2. The method of claim 1, further comprising:
iteratively repeating the transmitting element until a retry period lapses, or a response to the request is received from the target computing appliance.

3. The method of claim 1, further comprising:
forwarding a response from the target computing appliance to the requesting client computing appliance.

4. The method of claim 1, further comprising:
directing the requesting client computing appliance to automatically issue the request to an alternate target computing appliance upon a lapse of a retry period.

5. The method of claim 1, wherein forwarding the request to the target computing appliance comprises:
determining whether a host network device has resources available with which to support the received request; and
forwarding the request to the target computing appliance if it is determined that the host network device has resources to support the received request.

6. The method of claim 5, wherein the resources include one or more of memory resources, bandwidth resources, connectivity resources, and processing resources.

7. The method of claim 5, further comprising:
sending the retry message should the host network device fail to have adequate resources to support the received request.

8. The method of claim 1, further comprising specifying a period of time after which to issue the retry message.

9. An article of manufacture comprising:
a machine-accessible medium including content that, when executed by an accessing electronic system, cause the electronic system to implement a process of:
receiving a request from a computing appliance directed to a target computing appliance;
selectively forwarding the received request to the target computing appliance; and
transmitting a retry message to the requesting computing appliance, if a response to the forwarded request is not received from the target computing appliance, the retry message causing the requesting computing appliance to automatically issue another request.

10. The article of manufacture of claim 9, wherein the machine-accessible medium further comprises content that, when executed, cause the electronic system to transmit a response from the target computing appliance to the requesting computing appliance.

11. The article of manufacture of claim 9, wherein the content to transmit a retry message is iteratively invoked until a retry period lapses, or until a response is received from the target computing appliance.

12. The article of manufacture of claim 9, further comprising content that, when executed, cause an electronic system to generate a redirect message, sent to the requesting computing appliance, to cause the requesting computing appliance to issue a request to an alternate target computing appliance.

13. The article of manufacture of claim 12, wherein the redirect message is generated and sent after a retry period lapses.

14. The article of manufacture of claim 9, wherein the sequences of instructions that, when executed, cause the electronic system to selectively forward the request to the target computing appliance include content that, when executed, cause the electronic system to:
determine whether the electronic system has resources available with which to support the received request; and
forward the request to the target computing appliance if it is determined that the electronic system has resources to support the received request.

15. The article of manufacture of claim 14, wherein the content to determine whether the electronic system has resources available with which to support the received request confirms an availability of one or more of memory resources, bandwidth resources, connectivity resources, and processing resources of the electronic system.

16. A network device comprising:
a retry module, to receive a request from a computing appliance directed to a target computing appliance, and selectively generate a retry message which, when received by the requesting computing appliance, causes the computing appliance to automatically re-issue the request to the target computing appliance.

17. A network device according to claim 16, wherein the retry module is invoked by the network device upon determination that the network device does not have resources available to service the request.

18. A network device according to claim 17, wherein resources include one or more of memory resources, connectivity resources, bandwidth resources and processing resources.

19. A network device according to claim 17, wherein the retry module is invoked by the network device when, after forwarding the received request to the target computing appliance, the target computing appliance fails to issue a response within a period of time.

20. A network device according to claim 19, wherein the retry module continues to generate and issue retry messages until a retry period has lapsed.

21. A network device according to claim 16, further comprising:
a redirect module, responsive to the retry module, to generate and issue a redirect message to the requesting computing appliance after a retry period has lapsed.

22. A network device according to claim 2 1, wherein the redirect message causes the requesting computing appliance to generate a request to an alternate target computing appliance.

23. A system, comprising:
a data repository to receive a request from a computing appliance to a target computing appliance;
a network traffic manager, coupled with the data repository, to selectively forward the request to the target computing appliance, and transmit a retry message to the requesting computing appliance if the response to the request is not received from the target computing appliance, the retry message causing the requesting computing appliance to automatically issue another request; and
a processor to determine communications between the computing appliance and the target computing appliance, based at least in part on whether the response to the request is received.

24. The system of claim 23, wherein the network traffic manager forwards the response from the target computing appliance to the requesting client computing appliance.

25. The system of claim 23, wherein the network traffic manager iteratively repeats the transmitting element until a retry period lapses, or the response to the request is received from the target computing appliance.

26. The system of claim 25, wherein the network traffic manager causes the requesting client computing appliance to automatically issue the request to an alternate target computing appliance upon a lapse of the retry period.

27. The system of claim 23, wherein the network traffic manager selectively forwards the request by:
determining whether a host network device has resources available with which to support the received request;
forwarding the request to the target computing appliance if it is determined that the host network device has resources to support the received request; and
transmitting the retry message if the host network device fails to have adequate resources to support the received request.

28. The system of claim 27, wherein the resources include one or more of memory resources, bandwidth resources, connectivity resources, and processing resources.
